(19) United States
(12) Patent Application Publication
(10) Pub. No.: US 2013/0205017 A1
(43) Pub. Date: Aug. 8, 2013

(54) COMPUTER FAILURE MONITORING METHOD AND DEVICE

(71) Applicant: FUJITSU LIMITED, Kawasaki-shi (JP)

(72) Inventors: Atsuhito HIROSE, Kawasaki (JP); Takeshi Yamazaki, Kawasaki (JP); Toshihiro Kawakami, Kawasaki (JP); Daisuke Shimabayashi, Kawasaki (JP)

(73) Assignee: FUJITSU LIMITED, Kawasaki-shi (JP)

(21) Appl. No.: 13/752,459

(22) Filed: Jan. 29, 2013

(30) Foreign Application Priority Data
Feb. 3, 2012 (JP) 2012-022492

(51) Int. Cl. H04L 12/26

(52) U.S. Cl. CPC H04L 43/04
USPC 709/224

(57) ABSTRACT

Disclosed is a non-transitory computer-readable medium storing a program that causes a client device to execute a sequence of processing. The sequence of processing includes generating, by a processor, a processing request message by attaching status information including information indicating a status of a first server device stored in a storage part to a processing request addressed to the first server device, transmitting the generated processing request message to the first server device and a second server device monitoring the first server device, and receiving from the first server device a new status information of the first server device.

### CROSS-REFERENCE TO RELATED APPLICATION

This patent application is based upon, and claims the benefit of priority of Japanese Patent Application No. 2012-022492 filed on Feb. 3, 2012, the entire contents of which are incorporated herein by reference.

### FIELD

The embodiments discussed herein relate to a computer failure monitoring method and a computer failure monitoring device.

### BACKGROUND

With greater sophistication of recent server systems, there have been growing demands for an online system to insure high reliability and availability by continuously providing services 24 hours a day, 365 days a year without failure. In order to improve the availability of the system, adding redundancy to a server constituting the system may be given. In the system having the redundant server configuration, upon the failure of some server, another server may take over job services from the failed server to provide continued job services to prevent the outage of the job services. Further, in order to minimize an adverse effect on the job services of the failed server, the failed server may immediately be separated from a normally functioning server such that the normally functioning server may provide continued job services.

An example of a technology to add redundancy in the server constituting the system includes a cluster system. As an example of a typical cluster system, a high-availability (HA) cluster and a failover cluster may be given.

The HA cluster has a redundant server configuration having two or more servers to improve the availability of job services while minimizing system downtime.

The failover cluster is composed of an active server and a standby server. A server performing the job services is called the “active server”. A server taking over the job services when the active server fails is called the “standby server”. The existence of two or more standby servers may further improve the reliability of the system. A system for handing over job processing from the active server to the standby server is called “failover”.

The active server and the standby server are configured to transmit a signal called a “heartbeat” to or and receive the “heartbeat” from each other to mutually monitor as to whether the other party is running normally (dead-or-alive monitoring). The heartbeat means “the pulsation of the heart”, which specifically indicates a signal regularly transmitted between peripherals to report that the servers themselves are alive (normally operating).

The cluster system may be constructed per job service. Hence, when a server A and a server B are both capable of providing a job service X and a job service Y, the server A may serve as the active server while the server B may serve as the standby server for the job service X, whereas the server A may serve as the standby server while the server B may serve as the active server for the job service Y.

In general, apart of a system, which, if it fails, will stop the entire system from working, is called a “single point of failure”. For example, in a case where, after the failover, an active server C alone provides a job service Z and there is no standby server, the job service Z provided by the active server C is the single point of failure (SPOF). That is, when failure occurs in the job service Z provided by the active server C, it will stop providing the job service Z.

The single point of failure or SPOF may be eliminated by restoring the failed active server and incorporating the restored active server into the cluster system so as to restore the redundancy of the server configuration. However, the system, having the single point of failure (SPOF), remains in a dangerous condition until the failed active server is restored and the restored active server is incorporated into the cluster system.

In general, the system having increased multiplicity of redundancy for failure may exhibit high availability. However, resources, including hardware, may need to be covered corresponding to the increased redundancy, which may increase the cost of the system.

Further, policies or organizational controls relating to preparing for recovery or continuation of computer systems when they have failed after a disaster such as an earthquake or a fire may be called “disaster recovery”. The disaster recovery may, for example, be effective when the redundant parts of the systems are located in geographically remote areas.

In this case, it may be necessary to prepare a backup site at a place remotely located from a site where the active server resides. The dead-or-alive monitoring and data synchronization may frequently be performed between the servers constituting the cluster system. Hence, a dedicated line having a wide bandwidth may generally be provided between these servers. However, the setting of the dedicated line in the remote area may lead to an increase in cost.

Further, even if the redundancy of the job service is triplicated or more, such monitoring between the servers constituting the cluster system may malfunction due to the failure of the dedicated line set to detect the heartbeat. In this case, a group of standby servers may be separated from the active server, and as a result, the job service provided by the active server may become a single point of failure (SPOF). When failure occurs in the job service that is an SPOF, the failure may stop providing the job service entirely as described above. Accordingly, in order to prevent the outage of the job service, it may be necessary to find the SPOF so as to rapidly eliminate the SPOF.

Further, it may be possible to implement the redundancy of the server by setting the network that the active server utilizes for providing the job service as a network for the dead-or-alive monitoring. However, this may put an extra load on the network for providing the job service, which may adversely affect the system performance.

In a related art client-server system, there is disclosed a technology to detect, when network traffic is at a certain threshold or more, the network traffic as abnormal traffic (see Patent Document 1).

Further, in an internet protocol (IP) telephone system, there is a technology for detecting abnormality in the IP telephones. In this technology, an accessibility verification part multicast transmits an accessibility verification multicast packet to each of the IP telephones. Then, the abnormalities in the IP telephones are detected by determining whether there is a response from each of the IP telephones within a predetermined period (see Patent Document 2).

### RELATED ART DOCUMENT

### Patent Document

Patent Document 1: Japanese Laid-open Patent Publication No. 11-17549
Patent Document 2: Japanese Laid-open Patent Publication No. 2009-206862

### SUMMARY

According to an aspect of the embodiments, there is provided a non-transitory computer-readable medium storing a program, which causes a client device to execute a sequence of processing. The sequence of processing includes generating, by a processor, a processing request message by attaching status information including information indicating a status of a first server device stored in a storage part to a processing request addressed to the first server device; transmitting the generated processing request message to the first server device and a second server device monitoring the first server device; and receiving from the first server device a new status information of the first server device.

The object and advantages of the invention will be realized and attained by means of the elements and combinations particularly pointed out in the appended claims.

It is to be understood that both the foregoing general description and the following detailed description are exemplary and explanatory and are not restrictive of the invention.

Additional objects and advantages of the embodiments will be set forth in part in the description which follows, and in part will be obvious from the description, or may be learned by practice of the invention.

### BRIEF DESCRIPTION OF THE DRAWINGS

FIG. 1 is a diagram illustrating a system environment according to an embodiment;

FIG. 2 is a functional block diagram of a system according to an embodiment;

FIGS. 3A to 3C are diagrams illustrating examples of job service dead-or-alive information tables;

FIG. 4 is a diagram illustrating an example of a job service dead-or-alive information delivery list;

FIG. 5 is a flowchart illustrating an outline of a process in which a cluster system is monitored in normal processing;

FIG. 6 is a flowchart illustrating a process in which an active server updates a job service dead-or-alive information table;

FIG. 7 is a flowchart illustrating a process performed by a client when connection is established;

FIG. 8 is a flowchart illustrating a process performed by an active server in an active site when connection is established;

FIG. 9 is a flowchart illustrating a process performed by a standby server in the active site when connection is established;

FIG. 10 is a flowchart illustrating a process performed by a spare server in a monitoring/backup site when connection is established;

FIG. 11 is a functional block diagram of a system according to another embodiment;

FIG. 12 is a flowchart illustrating an outline of a process in which a spare server joins a cluster system;

FIG. 13 is a flowchart illustrating details of the process in which the spare server joins the cluster system;

FIG. 14 is a flowchart illustrating an outline of a process in which the spare server leaves the cluster system; and

FIG. 15 is a diagram illustrating a hardware configuration of a client and a server.

### DESCRIPTION OF EMBODIMENTS

According to embodiments described below, useful information for monitoring server failure may be acquired.

In the following embodiments, a cluster system is described as an example; however, the embodiments are not limited to the cluster system. Further, although the embodiments are described with accompanying drawings, the drawings are not utilized for limiting the invention but for clarifying details of the embodiments.

Note that reference numerals initially used in one drawing may be used in other drawings.

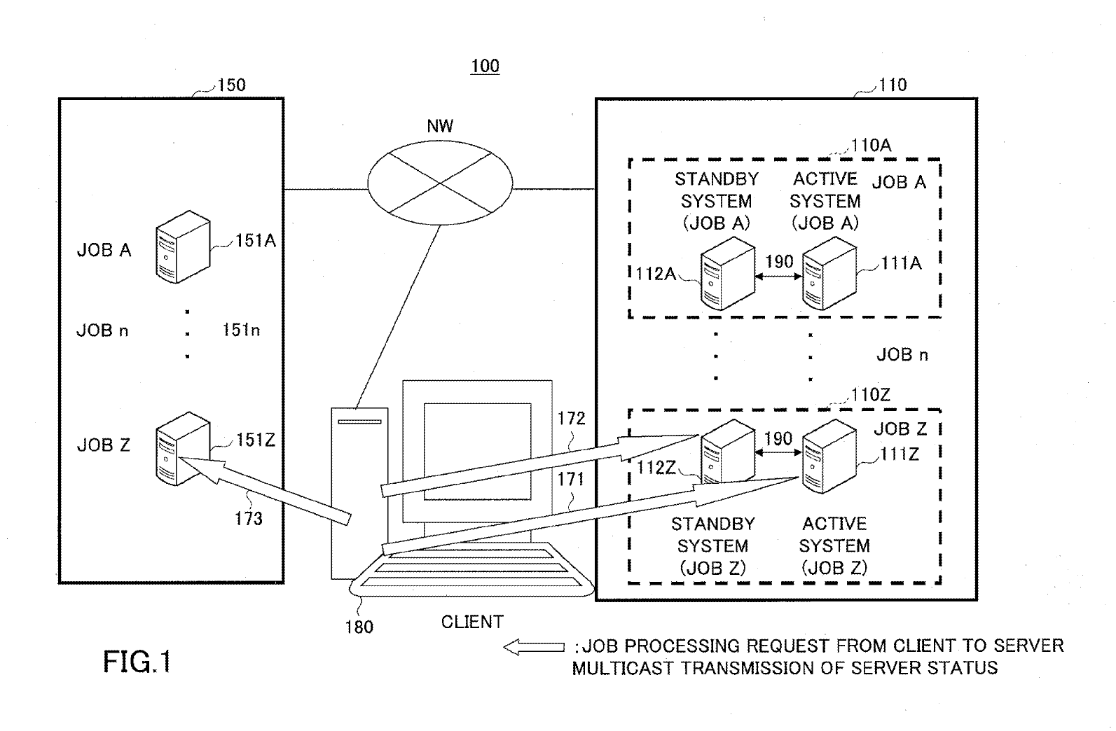

FIG. 1 is a diagram illustrating a system environment 100 according to an embodiment. The embodiments illustrated below include the system environment 100 illustrated in FIG. 1 as a precondition; however, the embodiments are not limited to that system environment.

As illustrated in FIG. 1, the system environment 100 includes an active site 110, a monitoring/backup site 150, and a client 180, which are mutually connected via a network NW. Note that there may be two or more clients 180.

The active site 110 may provide two or more job services A to Z to the client 180. For example, a cluster system that provides a job A service includes an active server 111A and a standby server 112A. Note that there may be two or more standby servers 112A. The active server 111A and the standby server 112A are connected to each other via a dedicated line 190 having a wide bandwidth. Both servers 111A and 112A may mutually perform the dead-or-alive monitoring and data synchronization via the dedicated line 190. When the active server 111A fails, the standby server 112A takes over for the failed active server 111A to serve as the active server 111A. Accordingly, the standby server 112A now serving as the active server 111A may provide the continued job service A by utilizing a failover function of a cluster system 110A. Thus, the continued job A service may be secured in this manner.

In the monitoring/backup site 150, there is a server 151A for providing the continued job A service that has been provided from the active site 110. The server 151A includes a hardware configuration and a software configuration equivalent to those of the servers 111A and 112A in the active site 100. Accordingly, the server 151A may be able to join or leave the cluster system associated with the job A service by monitoring the job A service provided by the active site. The server 151A in the monitoring/backup site 150 may be separated from the cluster system 110A associated with the job A service so as to monitor the cluster system 110A insofar as the active server 111A and the standby server 112A of the cluster system 110A associated with the job A service are running normally. In this case, the server 151A may serve as a part of another cluster system associated with another job in the monitoring/backup site 150. Similarly, there may be servers 151n to 151z for monitoring jobs n to z or backing up the jobs in the monitoring/backup site 150.

Note that in the description, each of the servers is assigned to a corresponding one of the job services; however, one server may be assigned to two or more job services. Further, the servers may be a physical machine or a virtual machine.

Further, there is the client 180 in FIG. 1. The client 180 is configured to receive at least one of the jobs A to Z services provided by the active server in the active site 110 via the network NW. The client 180 may receive the job Z service. For example, the client 180 may multicast transmit processing request messages 171, 172, and 173 associated with the job Z to servers 111Z, 112Z, and 151Z, respectively.

In FIG. 1, the active site 110 and the monitoring/backup site 150 are connected via the network NW utilized for the job services. That is, the active site 110 and the monitoring/backup site 150 are not necessarily connected via the dedicated line 190 having a wide bandwidth. Note that the active site 110 and the monitoring/backup site 150 may reside in geographically remote areas or geographically close areas.

It may be preferable not to constantly incorporate the servers 151A to 151Z existing in the backup site into the cluster systems in the active site. The main function of the monitoring/backup site may include rapidly detecting a single point of failure (SPOF) of the cluster system in the active site, and/or temporarily joining the cluster system while the SPOF in the active site is present to eliminate the SPOF.

Note that details of operations of the system environment 100 will be described later.

The details of the following embodiments may largely be divided into the two embodiments (A) and (B) as noted below, which will be described sequentially.

Embodiment (A): A case in which a spare server in the monitoring/backup site monitors for an SPOF of the cluster system in the active site
Embodiment (B): A case in which a server in the monitoring/backup site joins or leaves the cluster system in the active site when there is an SPOF of the cluster system in the active site

Note that the following embodiments are not exclusive to one another. That is, a part of one embodiment may optionally be combined with another embodiment.

### Embodiment

Embodiment (A): A case in which a spare server in the monitoring/backup site monitors for an SPOF of the cluster system in the active site

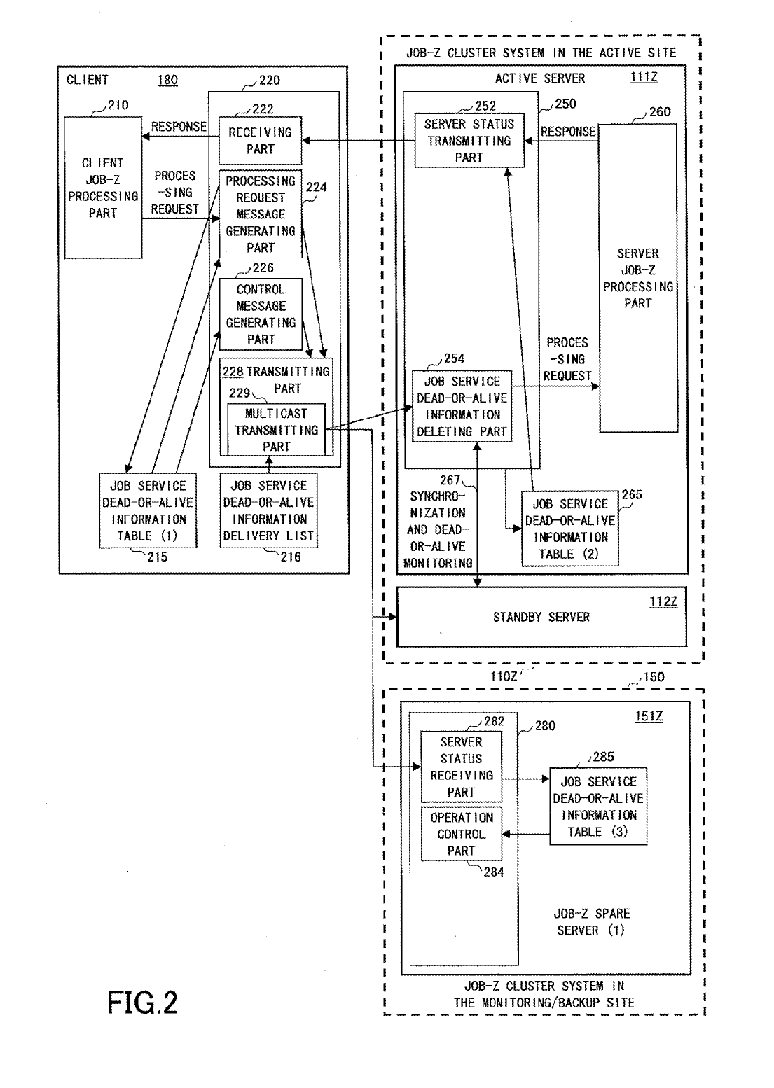

FIG. 2 is a functional block diagram of a system according to an embodiment. FIG. 2 is a diagram illustrating an example of a function associated with the job Z in FIG. 1.

The client 180 includes a client job-Z processing part 210, a client control part 220, a job service dead-or-alive information table (1) 215, and a job service dead-or-alive information delivery list 216.

The client job-Z processing part 210 may be an application program that provides scheduling management. The client job-Z processing part 210 may, for example, provide a processing request to a server job-Z processing part 260 of an active server 111Z. The client job-Z processing part 210 may then perform the scheduling management job upon receiving a response from the server job-Z processing part 260.

The client control part 220 may include a function to mediate a processing request from the client job-Z processing part 210, and a response from the server job-Z processing part 260, the job service dead-or-alive information table (1) 215, and the job service dead-or-alive information delivery list 216. The client control part 220 may include a receiving part 222, a processing request message generating part 224, a control message generating part 226, and a transmitting part 228. The transmitting part 228 may preferably include a multicast transmitting part 229. The client control part 220 may utilize the job service dead-or-alive information table (1) 215, and the job service dead-or-alive information delivery list 216.

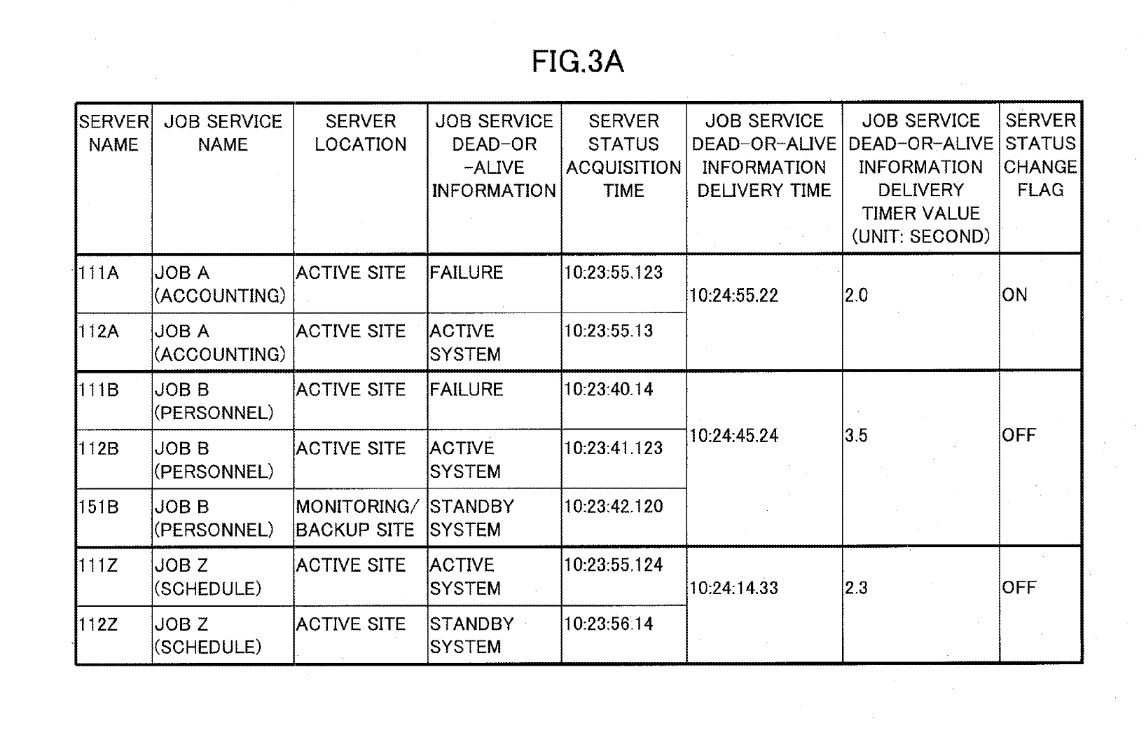

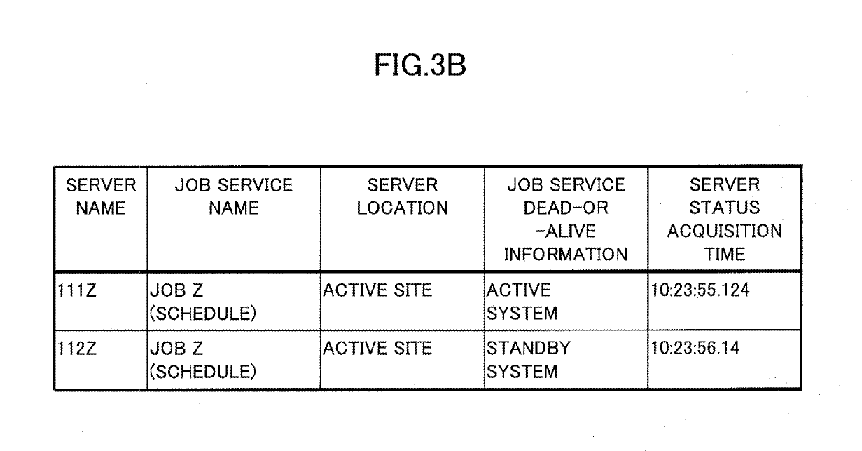

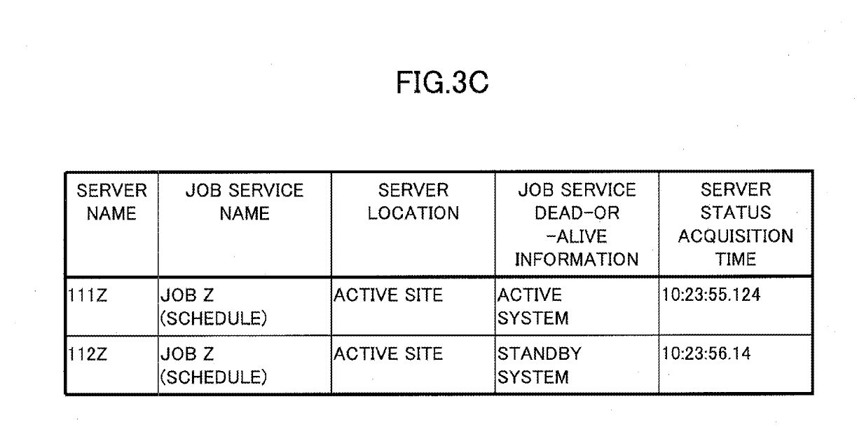

The job service dead-or-alive information table (1) 215 includes information on statuses of the servers classified by job type. A specific example of the job service dead-or-alive information table (1) 215 is depicted in FIG. 3A. Note that details of the job service dead-or-alive information table (1) 215 illustrated in FIG. 3A are described later.

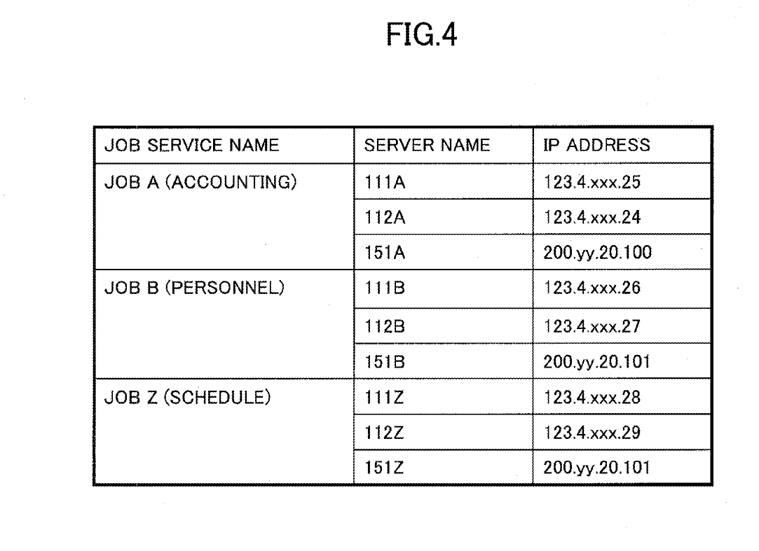

The job service dead-or-alive information delivery list 216 is a list having server addresses utilized by the multicast transmitting part 229 to multicast transmit a message associated with the job to the servers associated with that job. A specific example of the job service dead-or-alive information delivery list 216 is illustrated in FIG. 4. Note that details of the job service dead-or-alive information delivery list 216 illustrated in FIG. 4 are described later.

The receiving part 222 is configured to return a processing result back to the client job-Z processing part 210. Further, the receiving part 222 may include a function to extract server status information attached to a response message from each of the servers so as to accumulate the extracted server status information in the job service dead-or-alive information table (1) 215.

The processing request message generating part 224 may include a function to attach information of the job service dead-or-alive information table (1) 215 to the processing request from the client job-Z processing part 210 to generate a processing request message.

The control message generating part 226 may generate the information of the job service dead-or-alive information table (1) 215 as a control message when a processing request is not received from the client job-Z processing part 210 within a predetermined time (e.g., a heartbeat time interval utilized in the job-Z cluster system), and information associated with the job Z of the job service dead-or-alive information table (1) 215 is changed within that predetermined time. The control message is multicast transmitted to each of the servers. With this function, even when a processing request is not generated within the predetermined time, information of a job service dead-or-alive information table (3) 285 managed by a job-Z spare server (1) 151Z in the monitoring/backup site may be updated. Accordingly, the job-Z spare server (1) 151Z in the monitoring/backup site may be able to constantly monitor a status of the cluster system.

In addition, as illustrated in FIG. 2, a job-Z cluster system 110Z in the active site includes the active server 111Z and the standby server 112Z. As mentioned earlier, it is preferable to have two or more standby servers 112Z; however, the cost of the system may be increased according to an increased number of the standby servers. FIG. 2 illustrates an example of the cluster system that includes a minimum number of servers constituting the cluster system. Further, the configuration of the active server 111Z may preferably be similar to that of the standby server 112Z; however, the active server 111Z and the standby server 112Z may include mutually different hardware components or software components. Note that in such a case, it may be necessary for the active server 111Z and the standby server 112Z to have installed the software necessary for configuring the cluster system, and to satisfy a minimum hardware specification.

The active server 111Z may preferably include a server control part 250, the server job-Z processing part 260, a job service dead-or-alive information table (2) 265, and a dedicated line 267 for synchronization and the dead-or-alive monitoring (heartbeat) between the active server 111Z and the standby server 112Z.

A job service dead-or-alive information table (2) 265 may be updated by the server control part 250. The server control part 250 may preferably monitor dead or alive status of the standby server 112Z and reflect the monitored status of the standby server 112Z in the job service dead-or-alive information table (2) 265. A specific example of the job service dead-or-alive information table (2) 265 is illustrated in FIG. 3B. Details of the job service dead-or-alive information table (2) 265 are described later.

The server job-Z processing part 260 may, for example, receive a processing request from the client 180 and return a processing result corresponding to the received processing request to the client 180 as a response. The server job-Z processing part 260 may be an application program that processes a job Z (e.g., scheduling management).

A server status transmitting part 252 may include a function to attach information of the job service dead-or-alive information table (2) 265 to the response from the server job-Z processing part 260 so as to generate a responding message and transmit the generated responding message to the client 180. The server status transmitting part 252 may further include a function to generate a message including information associated with the heartbeat time interval and to transmit the generated message to the client 180.

A job service dead-or-alive information deleting part 254 may delete the job service dead-or-alive information from the message transmitted from the client 180 so as to extract the processing request from the client 180 and transmit the extracted processing request to the server job-Z processing part 260. The job service dead-or-alive information is information of the job service dead-or-alive information table (2) 265 updated with the information transmitted previously by the active server 111Z to the client 180, and information associated with other jobs. Hence, it may be possible to delete the job service dead-or-alive information.

The message may also be multicast transmitted to the standby server 112Z from the client 180. Note that the standby server 112Z may simply delete the multicast transmitted message.

The description will continue by referring back to FIG. 2. There is at least one job-Z spare server (1) 151Z in the monitoring/backup site 150.

The job-Z spare server (1) 151Z may preferably include at least a monitoring function to monitor the job-Z cluster system 110Z in the active site. The job-Z spare server (1) 151Z may preferably include at least a server control part 280 and a job service dead-or-alive information table (3) 285 so as to serve as a function to monitor two or more servers of the job-Z cluster system 110Z in the active site. Further, the job-Z spare server (1) 151Z may have a function to actively (voluntarily) join the job-Z cluster system 110Z when a single point of failure (SPOF) has occurred in the job-Z cluster system 110Z in the active site, and to actively (voluntarily) leave the job-Z cluster system 110Z when the failure of the cluster system is restored. Note that details of this function are described later in the embodiment (B).

A server status receiving part 282 is configured to receive a message that is multicast transmitted from the client 180. The server status receiving part 282 is further configured to extract information associated with the job Z from the job service dead-or-alive information contained in the message, and update the job service dead-or-alive information table (3) 285 with the extracted information. By carrying out the above processing, statuses of the two or more servers of the job-Z cluster system 110Z in the active site may be accumulated in the job service dead-or-alive information table (3) 285 while the information of the job service dead-or-alive information table (3) 285 is updated.

An operation control part 284 is configured to retrieve content of the job service dead-or-alive information table (3) 285 and monitor as to whether there is a single point of failure (SPOF) present in the job-Z cluster system 110Z. The operation control part 284 may send a notice to an operator such that the operator acknowledges the monitored information. Alternatively, the operation control part 284 may cause the job-Z spare server (1) 151Z to join or leave the job-Z cluster system 110Z as described later.

Note that FIG. 2 illustrates synchronous processing in which the client sends to the server a processing request, and the server returns to the client a processing result corresponding to the processing request from the client. However, asynchronous processing in which the client sends a processing request unilaterally, and the server does not return to the client a processing result corresponding to the processing request may be employed instead of the synchronous processing.

FIGS. 3A to 3C are diagrams illustrating examples of the job service dead-or-alive information tables, which may be stored in a not-illustrated storage part.

FIG. 3A illustrates an example of the job service dead-or-alive information table (1) 215 present in the client 180. The job service dead-or-alive information table (1) 215 may preferably include a server name, a job service name, a server location, job service dead-or-alive information, a server status acquisition time, a job service dead-or-alive information delivery time, a job service dead-or-alive information delivery timer value, and a server status change flag. The job service dead-or-alive information table (1) 215 includes accumulated information of statuses of the servers of the cluster system associated with a job utilized by the client 180. The information may be acquired by extracting the job service dead-or-alive information attached to the response to the active server 111Z and the like as described above. The information of the job service dead-or-alive information table (1) 215 may be multicast transmitted via the processing request message attached to the processing request or the control message attached to the processing request. Note that information associated with the job relating to the processing request message may be extracted from the job service dead-or-alive information table (1) 215, and the extracted information may only be attached to the processing request message.

The server name is unique identifier information assigned to each of the servers.

The job service name is information specifying a job service provided by the cluster system.

The server location may be one of the active site and the monitoring/backup site, for example. The server location may be used for determining whether the server itself serves as a spare server in the monitoring/backup site 150 that joins the cluster system when the server actively (voluntarily) leaves the monitoring/backup site 150. Further, the server in the active site will not be allowed to actively (voluntarily) leave the cluster system by referring to information on the server location.

The job service dead-or-alive information may be an active status (job service operable status), a standby status (job service switchable status), activating status (switching from standby status to active status), a stop status, a starting status (switching from stop status to standby status), a stopping status (switching from active or standby status to stop status), a failing status (faulted), and a data synchronization status. For example, when only the active server in the active site is running and there is no standby server (e.g., faulted case) in a specific job, the job provided by the active server in the active site may be a single point of failure (SPOF). In this case, only the active server is operating, which is in a dangerous condition. In this case, a server in the monitoring/backup site 150 may be caused to join the cluster system to eliminate the SPOF.

The server status acquisition time may be used for preventing the already registered information from being overwritten with the old information when the job service dead-or-alive information table (1) 215 is updated.

The job service dead-or-alive information delivery time includes a time when the client 180 transmits the information of the job service dead-or-alive information table (1) 215 last.

The job service dead-or-alive information delivery timer value may employ a heartbeat time interval of the cluster system corresponding to the job service.

The server status change flag indicates whether an entry of the job service dead-or-alive information table (1) 215 associated with the job service is updated in a period from the time at which the client 180 transmits the information of the job service dead-or-alive information table (1) 215 last to the current time. The server status change flag indicating an “OFF” status illustrates that the entry of the job service dead-or-alive information table (1) 215 has not been updated. The server status change flag indicating an “ON” status illustrates that the entry of the job service dead-or-alive information table (1) 215 has been updated.

When a time indicated by the job service dead-or-alive information delivery timer value has elapsed since the job service dead-or-alive information delivery time, and the server status change flag indicates an “ON” status, the following processing may preferably be carried out. That is, the control message generating part 226 generates a control message including the job service dead-or-alive information, and multicast transmits the generated control message to the servers cited on the job service dead-or-alive information delivery list associated with the job service, of which the server status change flag indicates an “ON” status, without waiting for the generation of a next processing request. By carrying out the above processing, updated information of the job service dead-or-alive information table (1) 215 of the client 180 may be transmitted to the job-Z spare server (1) 151Z in the monitoring/backup site 150 at a time lag similar to the heartbeat time interval.

A spare server 151B in the monitoring/backup site 150 is listed in an entry of a job B (personnel). Since a server 111B in the active site 110 has failed, a server 112B in the active site 110 serving as the active server is running. That is, since a single point of failure (SPOF) has occurred in the job service B in the active site 110, the spare server 151B in the monitoring/backup site 150 joins the cluster system associated with the job B as the standby server. As described above, the spare server in the monitoring/backup site 150 may be listed in the job service dead-or-alive information table (1) 215 only when the spare server joins the cluster system. The spare server in the monitoring/backup site 150 may be listed in other job service dead-or-alive information tables (2) 265 and (3) 285 illustrated in FIGS. 3B and 3C, respectively, only when the spare server joins the cluster system in a manner similar to the job service dead-or-alive information table (1) 215.

FIG. 3B illustrates an example of the job service dead-or-alive information table (2) 265 managed by the active server 111Z. It is preferable that information of this job service dead-or-alive information table (2) 265 be attached to a response from the server job-Z processing part 260 and the response be transmitted to the client 180, such that the information of this job service dead-or-alive information table (2) 265 is used for updating of the job service dead-or-alive information table (1) 215.

FIG. 3C illustrates an example of the job service dead-or-alive information table (3) 285 managed by the job-Z spare server (1) 151Z. Information of this job service dead-or-alive information table (3) 285 is updated with the information contained in the message multicast transmitted from the client 180, that is, the information of the job service dead-or-alive information table (1) 215. The job-Z spare server (1) 151Z may be able to monitor the job-Z cluster system 110Z by referring to the job service dead-or-alive information table (3) 285. Further, when a single point of failure (SPOF) exists in the job-Z cluster system 110Z, an operation for eliminating the SPOF may be initiated as described later in the embodiment (B).

FIG. 4 illustrates an example of the job service dead-or-alive information delivery list. The job service dead-or-alive information delivery list may preferably include a server name, a job service name, and an Internet protocol (IP) address. The server name corresponding to a specific job service and a network address may be acquired from this job service dead-or-alive information delivery list. Note that the network address may be an address other than the IP address. The multicast transmitting part 229 may be able to multicast transmit the message to the servers associated with the job service relating to the message by referring to the job service dead-or-alive information delivery list. The job service dead-or-alive information delivery list may preferably store information on the active server 111Z and the standby server 112Z in the active site 110, and information on the spare server 151Z (i.e., the job-Z spare server) in the monitoring/backup site 156.

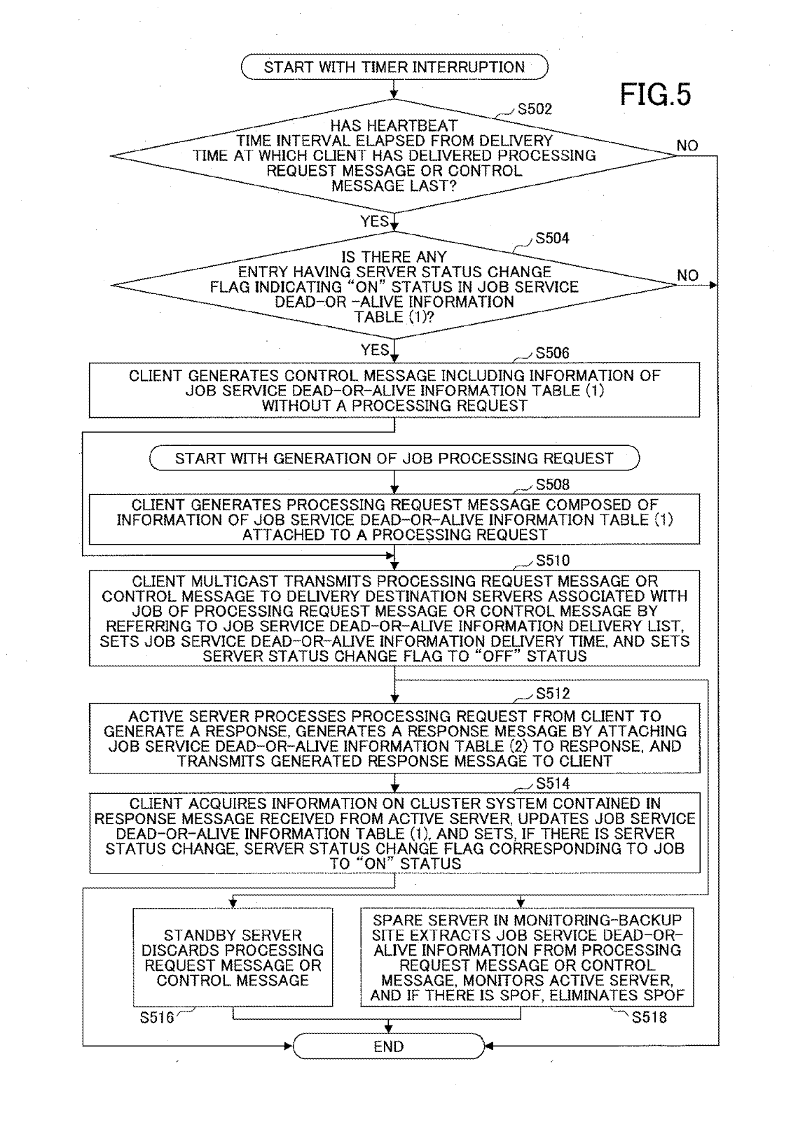

FIG. 5 is a flowchart illustrating an outline of a process in which a cluster system is monitored in normal processing. The normal processing indicates a flowchart of the normal processing without including initialization processing when the connection is established.

In step S502, it is determined whether a heartbeat time interval has elapsed from a delivery time at which the client 180 has delivered a processing request message or a control message last. If the determination in step S502 is “YES”, the information of the job service dead-or-alive information table (1) 215 has not been multicast delivered to each of the servers in a period longer than the heartbeat time interval. Note that the determination in step S502 is obtained by comparing the difference between the delivery time of the information of the job service dead-or-alive information table (1) 215 and the current time, with the job service dead-or-alive information delivery timer value. It is preferable that step S502 be initiated by a regular timer interrupt. Further, it is preferable that an interval of the timer interruption be sufficiently shorter than the heartbeat timer value. Note that the interval of the timer interruption is not limited to the heartbeat timer value, and may be set to a time interval other than the heartbeat timer value. If the determination in step S502 is “NO”, the normal processing of the cluster system monitoring may be ended. If the determination in step S502 is “YES”, step S504 is processed.

In step S504, it is determined whether there is an entry having the server status change flag indicating an “ON” status in the job service dead-or-alive information table (1) 215. If the determination in step S504 is “YES”, the information of the job service dead-or-alive information table (1) 215 has not been multicast transmitted to each of the servers in a period from a transmission time at which the information of the job service dead-or-alive information table (1) 215 has been multicast transmitted last to a current time, and the period is longer than the heartbeat time interval. This condition indicates that although the status of the cluster system has changed, the information of the changed status has not been transmitted to the spare server 151Z in the monitoring/backup site in a certain period of time (i.e., the period longer than the heartbeat time interval). If the determination in step S504 is “NO”, the normal processing of the cluster system monitoring may be ended due to the fact that no information has changed in the job service dead-or-alive information table (1) 215. If the determination in step S504 is “YES”, step S506 is processed.

In step S506, the client 180 generates a control message including the information of the job service dead-or-alive information table (1) 215 without a processing request. The control message is generated in order to transmit the information of the job service dead-or-alive information table (1) 215 to the monitoring/backup site that monitors the cluster system without waiting for a processing request transmitted from the client job-Z processing part 210. Subsequently, step S510 is processed; however, step S508 is described prior to the illustration of step S510.

Step S508 is initiated when the client 180 generates a processing request. In step S508, a processing request message composed of the information of the job service dead-or-alive information table (1) 215 attached to a processing request is generated. In step S508, the processing request is not unicast transmitted to the active server 111Z. Instead, a message composed of the information of the job service dead-or-alive information table (1) 215 attached to the processing request is generated, and the generated message (i.e., processing request message) is multicast transmitted to the spare server 151Z that monitors the cluster system in addition to the active server 111Z. Hence, the processing request and the information for monitoring may be transmitted simultaneously, which may allow the transmission of plural types of information and the performance of plural types of processing (i.e., handling the processing request and monitoring the cluster system) while suppressing an increase in the traffic as much as possible. Note that information associated with the job relating to the processing request message may be extracted from the job service dead-or-alive information table (1) 215, and the extracted information may only be attached to the processing request so as to generate the processing request message. Further, the processing request message may include an instruction to request the active server 111Z to transmit information associated with respective statuses of the active server 111Z and the standby server 112Z that constitute the cluster system as a response message. In this case, when this instruction is processed, the active server 111Z may attach the information associated with the statuses to the response message, and transmit (return) the response message to the client 180, as described later.

In step S510, the client 180 multicast transmits the processing request message or the control message to the delivery destination servers associated with the job service of the processing request message or the control message by referring to the job service dead-or-alive information delivery list 216. The job service dead-or-alive information delivery time includes a transmission time at which the client 180 transmits the message to the information of the job service dead-or-alive information table (1) 215. Then, the server status change flag associated with the job relating to the job service dead-or-alive information table (1) 215 may be set to an “OFF” status.

In step S512, the active server 111Z receives the message, processes the processing request from the client 180 to generate a response, generates a response message by attaching information of the job service dead-or-alive information table (2) 265 to the response, and transmits the generated response message to the client 180. For example, the job service dead-or-alive information table (2) 265 managed by the active server 111Z may include dead-or-alive information of the standby server 112Z constituting the cluster system (see FIG. 3B). Accordingly, the client 180 may be able to acquire the latest version of information on the processing request result and the server associated with the cluster system by receiving the response message. Hence, two types of information may be transmitted to the client 180 while minimizing an increase in the traffic by incorporating the information on the job processing response and the server associated with the cluster system into the response message. Note that the response message may preferably be unicast transmitted. Note that as illustrated in step S508, the information of the job service dead-or-alive information table (2) 265 may only be attached to the response message when the processing request message includes an instruction to request the active server 111Z to transmit information associated with respective statuses of the active server 111Z and the standby server 112Z that constitute the cluster system.

In step S514, the client 180 may acquire information on the cluster system contained in the response message received from the active server 111Z, update the job service dead-or-alive information table (1) 215, and if there is a server status change, set the server status change flag corresponding to the job to an “ON” status. Note that in this step of processing, it is preferable to check the server status acquisition time corresponding to the job service in the job service dead-or-alive information table (1) 215. Accordingly, when the server status acquisition time recorded in the job service dead-or-alive information table (1) 215 is newer than the server status acquisition time attached to the information acquired from the server 111Z, it may be possible to prevent the job service dead-or-alive information table (1) 215 from being overwritten with the old information by monitoring the server status acquisition time. The process is ended thereafter.

Step S516 illustrates processing performed by the standby server 112Z. In the multicast transmission of the message, the message may be transmitted to the standby server 112Z. In this case, the standby server 112Z may simply discard the multicast transmitted message. Note that when the standby server 112Z serves as the active server, the standby server 112Z may attach its own job service dead-or-alive information to the message by referring to its own job service dead-or-alive information table, and transmits (returns) the message with its own job service dead-or-alive information to the client 180.

Step S518 illustrates processing performed by the spare server (i.e., the job-Z spare server) 151Z in the monitoring/backup site. The spare server 151Z may preferably extract the job service dead-or-alive information from the processing request message or the control message, and update the job service dead-or-alive information table (3) 285 with the extracted information. The spare server 151Z may be able to monitor the job-Z cluster system 110Z in the active site by referring to the job service dead-or-alive information table (3) 285. When there is a single point of failure (SPOF) in the cluster system, the spare server 151Z may execute the elimination of the SPOF. Alternatively, the spare server 151Z may report the presence of the SPOF in the cluster system to an operator. Note that details of the elimination of the SPOF are described later in the embodiment (B). Note that when the spare server 151Z serves as the standby server or the active server, the spare server 151Z may attach its own job service dead-or-alive information to the message by referring to its own job service dead-or-alive information table (3) 285, and transmits (returns) the message with its own job service dead-or-alive information to the client 180.

By performing the series of processing, the spare server (i.e., the job-Z spare server) 151Z in the monitoring/backup site may be able to easily monitor the active server 111Z and the standby server 112Z present in the job-Z cluster system 110Z while suppressing an increase in the traffic of the network NW.

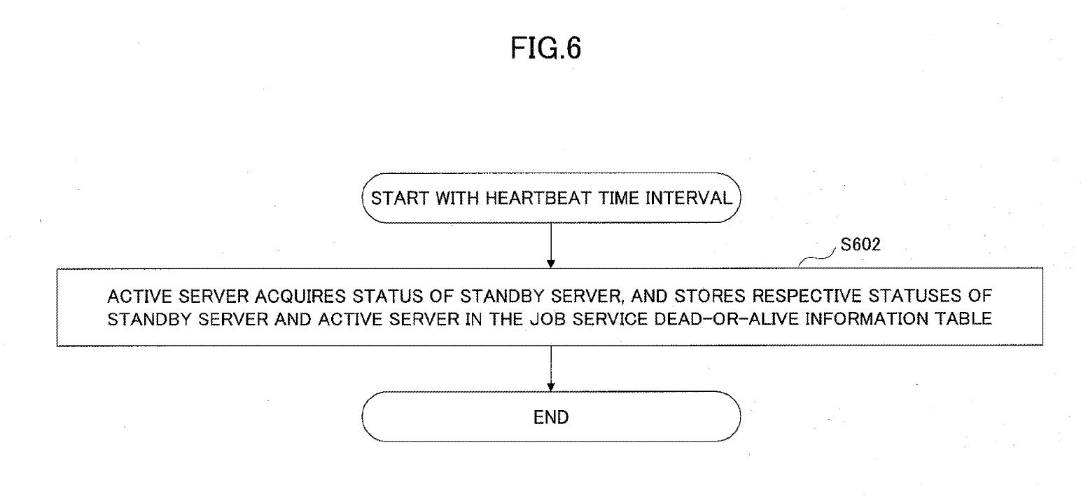

FIG. 6 is a flowchart illustrating a process in which the active server 111Z updates the job service dead-or-alive information table (2) 265.

In step S602, the active server 111Z acquires the status of the standby server 112Z, and stores the respective statuses of the standby server 112Z and the active server 111Z in the job service dead-or-alive information table (2) 265 (see FIG. 3B). In the cluster system, in general, the active server and the standby server mutually perform the dead-or-alive monitoring on each other at the heartbeat intervals. It is preferable that the results of the dead-or-alive monitoring be stored in the job service dead-or-alive information table (2) 265.

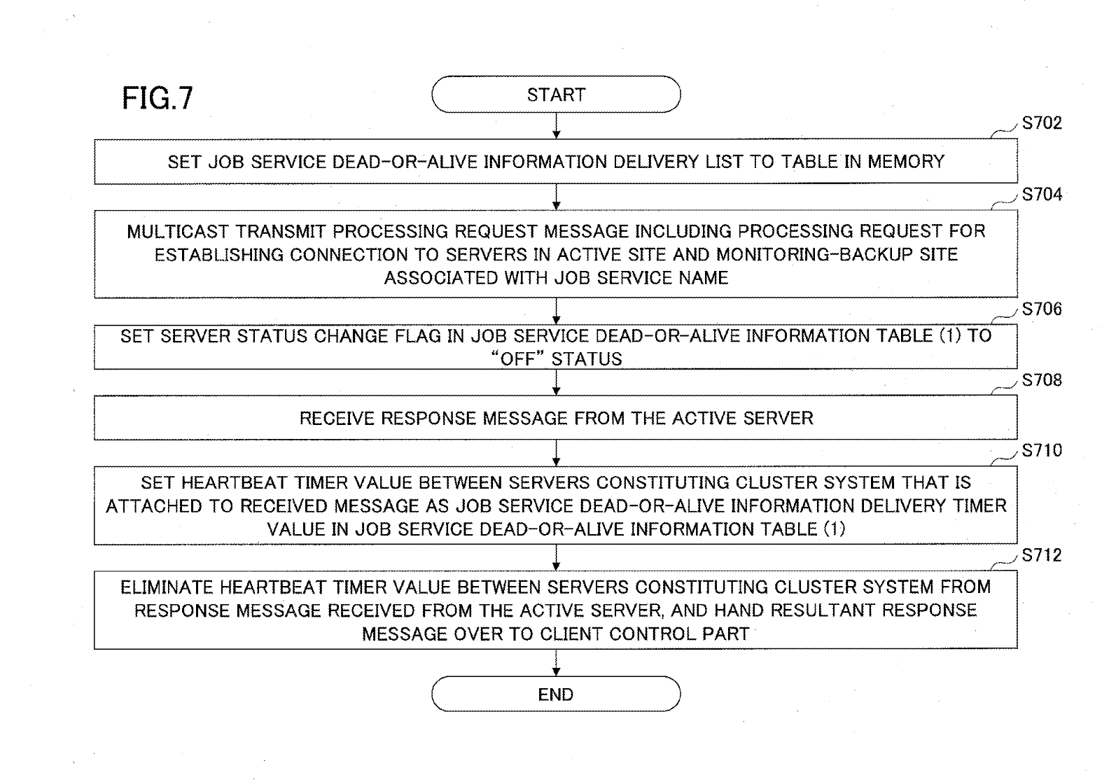

FIGS. 7 to 10 illustrate processes when the connection is established. The connection may need to be established correctly in order for the client 180 to perform the job processing in cooperation with the active server. Further, since the client 180 performs multicast transmission to the active server 111Z, the standby server 112Z, and the spare server 151Z in the monitoring/backup site 150, it may be preferable that the connection be established in advance.

FIG. 7 is a flowchart illustrating a process performed by the client 180 when connection is established.

In step S702, the job service dead-or-alive information delivery list is set in a table in memory.

The server name and the network address of the server relating to a specific job service may be stored in the client 180 in advance. Alternatively, the client 180 may search for and acquire the server name and the network address of the server associated with the specific job service by referring to a specific site on the network.

In step S704, the client 180 multicast transmits a processing request message including a processing request for establishing a connection to the servers in the active site and the monitoring/backup site associated with the job service name.

In step S706, the server status change flag in the job service dead-or-alive information table (1) 215 is set to an “OFF” status.

In step S708, a response message is received from the active server 111Z.

In step S710, the heartbeat timer value between the servers constituting the cluster system that is attached to the received message is set as the job service dead-or-alive information delivery timer value in the job service dead-or-alive information table (1) 215. It may be unnecessary to change the value set as the job service dead-or-alive information delivery timer value in the job service dead-or-alive information table (1) 215 thereafter. Further, a value other than the heartbeat timer value may be set as the job service dead-or-alive information delivery timer value. Note that in this step (step S710), information associated with the job service dead-or-alive information table (2) 265 may be acquired from the active server 111Z, and the acquired information may be stored in the job service dead-or-alive information table (1) 215 in the client 180.

In step S712, the heartbeat timer value between the servers constituting the cluster system (and optionally the information associated with the job service dead-or-alive information table (2) 265) are eliminated from the response message received from the active server 111Z, and the resultant response message is handed over to the client control part 220 that is an original transmitter of the processing request.

By performing the above steps of processing, the client 180 may be able to verify the establishment of the connection while setting the job service dead-or-alive information delivery timer value. Further, the client 180 may be able to acquire information relating to the job service dead-or-alive information table (2).

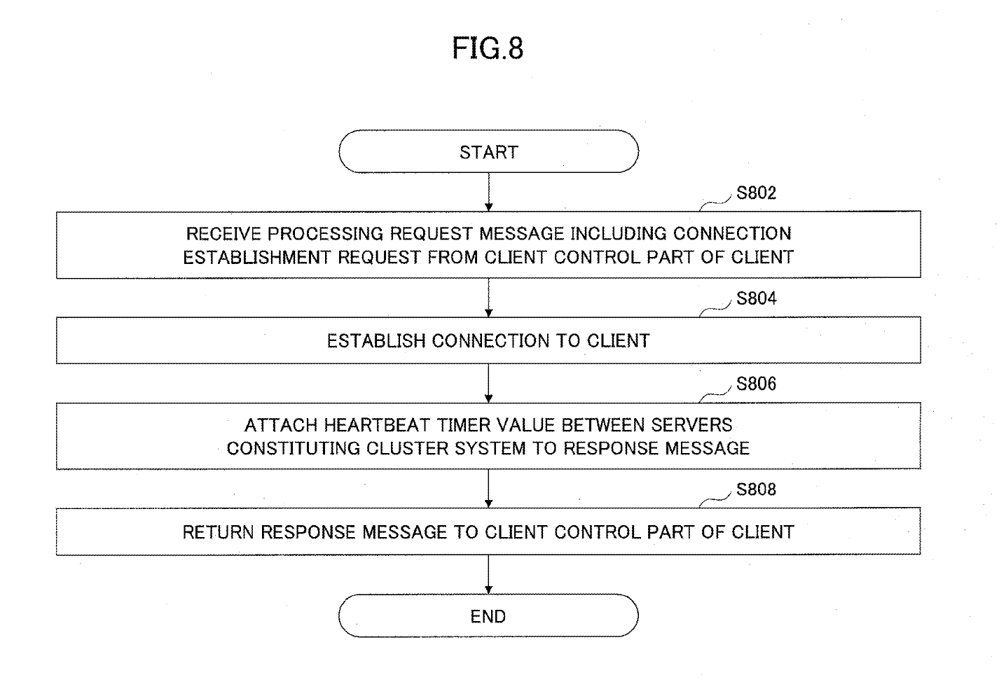

FIG. 8 is a flowchart illustrating a process performed by the active server 111Z in the active site 110 when connection is established.

In step S802, the active server 111Z receives a processing request message including a connection establishment request from the client control part 220 of the client 180.

In step S804, the active server 111Z establishes a connection to the client 180.

In step S806, the heartbeat timer value between the servers constituting the cluster system is attached to a response message. Note that in this step (step S806), information of the job service dead-or-alive information table (2) 265 managed by the active server 111Z may also be attached to the response message.

In step S808, the response message is returned to the client control part 220 of the client 180 that is an original transmitter of the processing request message.

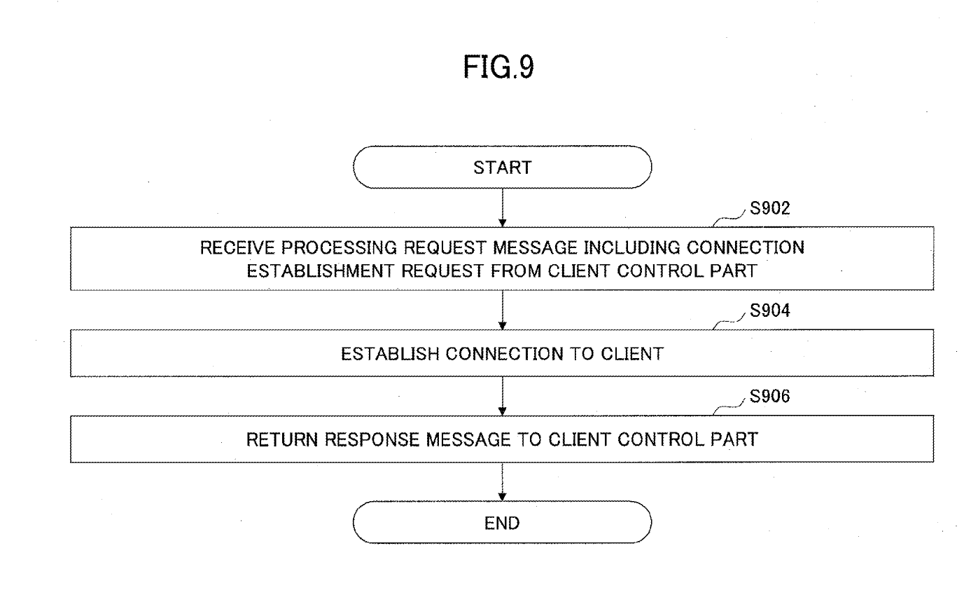

FIG. 9 is a flowchart illustrating a process performed by the standby server 112Z in the active site 110 when connection is established.

In step S902, a processing request message including a connection establishment request is received from the client control part 220.

In step S904, a connection to the client 180 is established.

In step S906, the response message is returned to the client control part 220 of the client 180 that is an original transmitter of the processing request message. It is preferable that the standby server 112Z return the response message associated with the connection establishment to the client 180 in order for the client 180 to verify whether the connection has reliably been established.

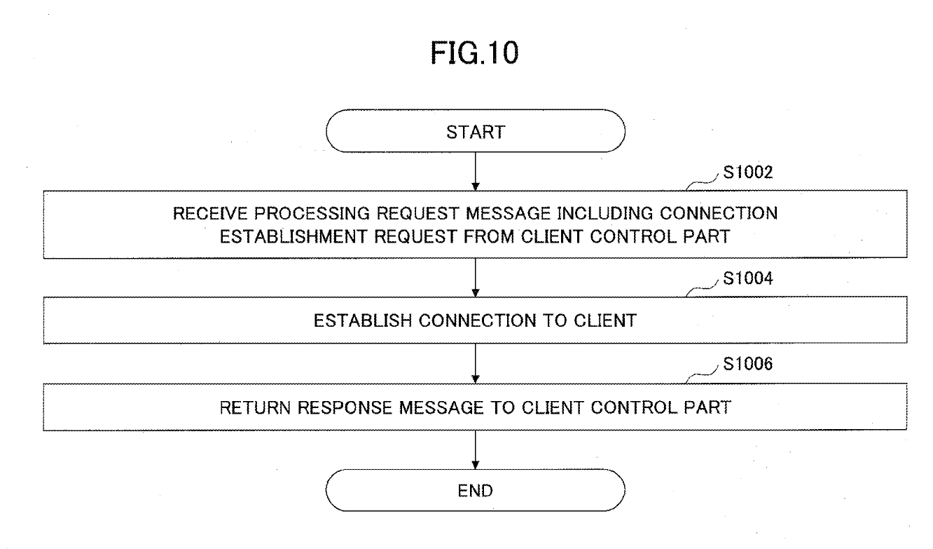

FIG. 10 is a flowchart illustrating a process performed by the spare server 151Z in the monitoring/backup site 150 when connection is established.

In step S1002, a processing request message including a connection establishment request is received from the client control part 220.

In step S1004, a connection to the client 180 is established.

In step S1006, the response message is returned to the client control part 220 of the client 180 that is an original transmitter of the processing request message. It is preferable that the spare server 151Z return the response message associated with the connection establishment to the client 180 in order for the client 180 to verify whether the connection has reliably been established.

By having performed the above steps of processing, it may be possible to verify that content of the job service dead-or-alive information delivery list 216 is accurate.

Embodiment (B): A case in which a server in the monitoring/backup site joins or leaves the cluster system in the active site when there is an SPOF of the cluster system in the active site

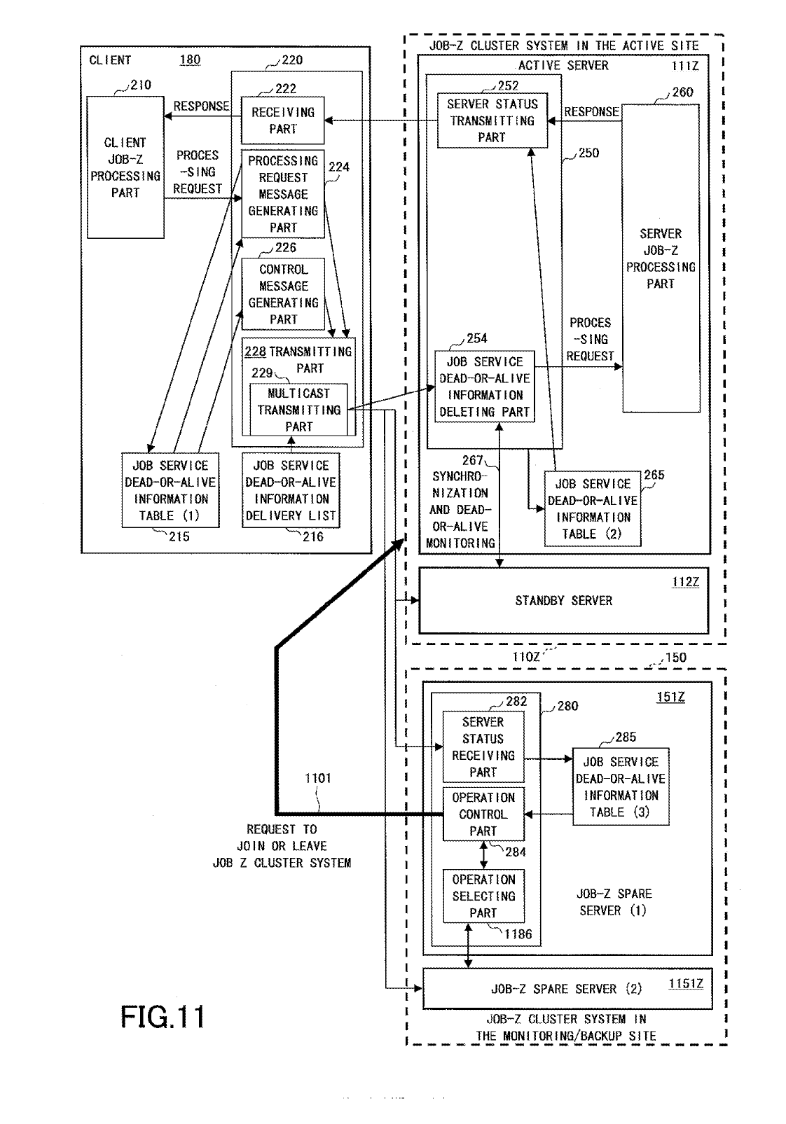

FIG. 11 is a functional block diagram of a system according to an embodiment. In FIG. 11, same reference numerals are assigned to components identical to those illustrated in FIG. 2. In FIG. 11, a new component, that is, a job-Z spare server (2) 1151Z is added to the configuration of FIG. 2. Note that the job-Z spare server (2) 1151Z is not a mandatory component. The server control part 280 of the job-Z spare server (1) 151Z may include an operation selecting part 1186. Further, it is preferable that the operation control part 284 be capable of transmitting a joining request 1101 for joining and a leaving request 1101 for leaving the job-Z cluster system 110Z. In addition, it is preferable that the job-Z spare server (1) 151Z be capable of leaving or joining another cluster system (not illustrated) in the monitoring/backup site 150.

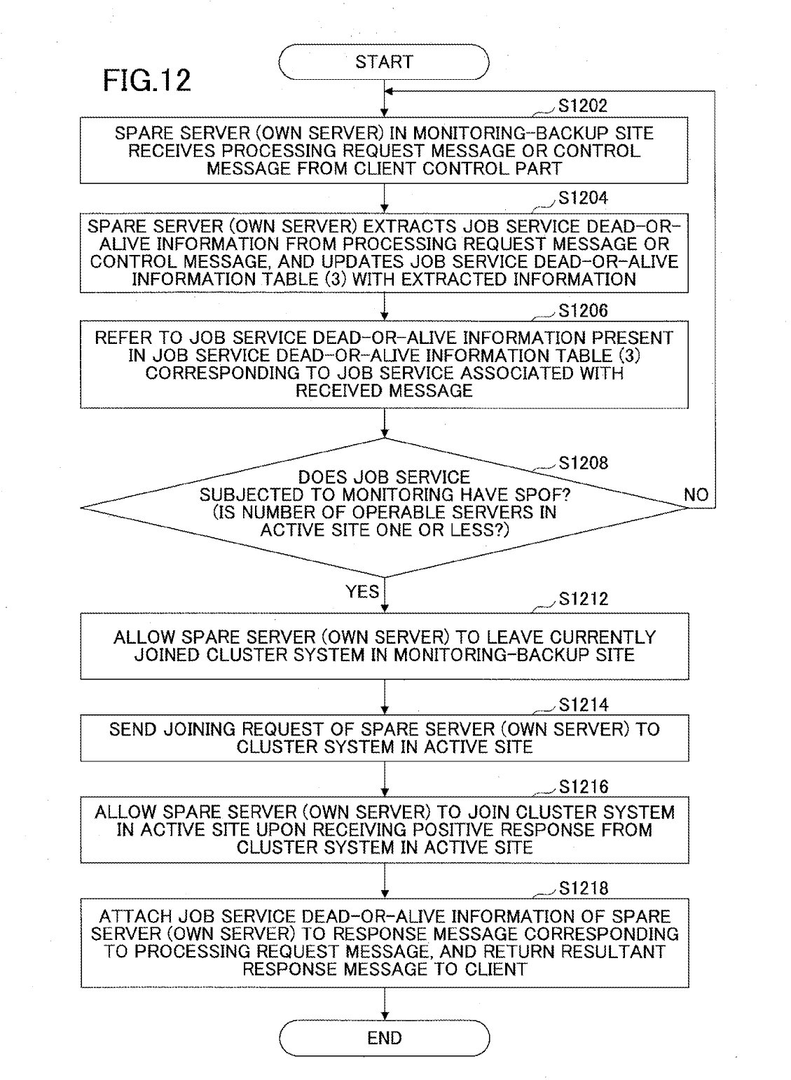

FIG. 12 is a flowchart illustrating an outline of a process in which the spare server (1) 151Z in the monitoring/backup site 150 joins the cluster system 110Z.

In step S1202, the spare server 151Z (own server) in the monitoring/backup site 150 receives a processing request message or a control message from the client control part 220.

In step S1204, the spare server 151Z (own server) preferably extracts the job service dead-or-alive information from the processing request message or the control message, and updates the job service dead-or-alive information table (3) 285 with the extracted information. By performing the step of processing, new statuses associated with the active server 111Z and the standby server 112Z in the cluster system 110Z may be accumulated in the job service dead-or-alive information table (3) 285. Note that in this step of processing, it is preferable to check the server status acquisition time in the job service dead-or-alive information table (3) 285. It may be possible to determine whether the acquired information is older than the accumulated information by checking the server status acquisition time in the job service dead-or-alive information table (3) 285. Hence, it may be possible to prevent the job service dead-or-alive information table (3) 285 from being overwritten with the old information by checking the server status acquisition time.

In step S1206, the job service dead-or-alive information present in the job service dead-or-alive information table (3) 285 corresponding to the job service associated with the received message is referred to.

In step S1208, whether the job service subjected to monitoring has a single point of failure (SPOF) is determined. It may be possible to determine whether the job service subjected to monitoring is an SPOF based on whether the number of operable servers in the active site is one or less. If the determination in step S1208 is “NO”, step S1202 is processed again (back to step S1202). If the determination in step S1208 is “YES”, step S1212 is processed.

In step S1212, the job-Z spare server (1) 151Z (own server) is caused to leave the currently joined cluster system in the monitoring/backup site. This is because the job-Z spare server (1) 151Z (own server) may serve as apart of another cluster system while monitoring the cluster system 110Z. In this case, it is preferable that the job-Z spare server (1) 151Z (own server) leave the currently joined cluster system in the monitoring/backup site in order to reduce the load on the cluster system 110Z. Note that it may also be possible not to allow the job-Z spare server (1) 151Z (own server) to leave the currently joined cluster system in the monitoring/backup site based on the processing capacity of the job-Z spare server (1). Note that in such a case, it is preferable that the job-Z spare server (1) 151Z actively leave the currently joined cluster system in the monitoring/backup site.

Further, when there are plural spare servers, the spare server corresponding to the lowest priority job service among the spare servers currently joining the cluster system may be selected. This selection is performed by the operation selecting part 1186 illustrated in FIG. 11. The selection standard may be formed by assigning priority for the job service dead-or-alive information (not illustrated) of the spare servers.

In step S1214, a joining request 1101 of the job-Z spare server (1) 151Z (own server) is transmitted to the cluster system 110Z in the active site. It is preferable that joining request 1101 be actively transmitted by the job-Z spare server (1) 151Z (own server).

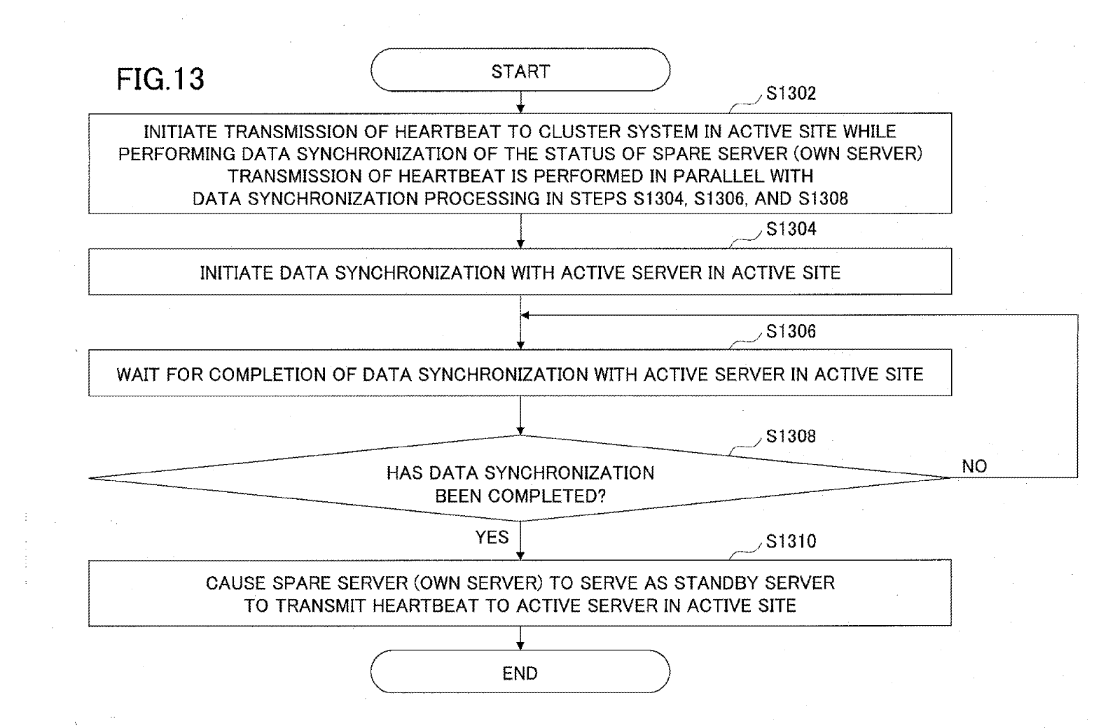

In step S1216, upon receiving a positive response from the cluster system 110Z in the active site, the job-Z spare server (1) 151Z (own server) is caused to join the cluster system 110Z in the active site. Note that details of a joining process are described later with reference to FIG. 13.

In step S1218, when the processing request message from the client 180 has arrived, the job service dead-or-alive information of the job-Z spare server (1) 151Z (own server) is attached to a response message corresponding to the processing request message by referring to the job service dead-or-alive information table (3) 285, and the resultant response message is returned to the client 180. By performing the above step of processing, the job service dead-or-alive information table (1) 216 managed by the client 180 may be updated.

According to the steps S1202 to S1218 of processing, the job-Z spare server (1) 151Z in the monitoring/backup site 150 joins the cluster system 110Z.

FIG. 13 is a flowchart illustrating details of the process in which the job-Z spare server (1) 151Z joins the cluster system 110Z.

In step S1302, the job-Z spare server (1) 151Z (own server) initiates transmission of a heartbeat to the cluster system 110Z in the active site while data synchronizing the status of the own server.

The transmission of the heartbeat is performed in parallel with the data synchronization processing in steps S1304, S1306, and S1308.

Note that after having joined the cluster system, the dead-or-alive monitoring may be performed on another server constituting the cluster system by utilizing a function of the cluster system.

In step S1304, the job-Z spare server (1) 151Z (own server) may initiate data synchronization with the active server 111Z in the active site. The data synchronization processing may be performed by not utilizing the dedicated line but utilizing the network NW for use in the job service. Note that data transfer traffic of the data synchronization may be reduced by utilizing a file-sharing function.

In step S1306, the job-Z spare server (1) 151Z (own server) waits for completion of the data synchronization with the active server 111Z in the active site.

In step S1308, it is determined whether the data synchronization has been completed. If the determination in step S1308 is “NO”, step S1306 is processed again (back to step S1306). If the determination in step S1308 is “YES”, step S1310 is processed.

In step S1310, the job-Z spare server (1) 151Z (own server) is caused to serve as the standby server to transmit a heartbeat to the active server in the active site. The transmission of the heartbeat may be performed by utilizing the network NW for the job service.

According to the steps S1302 to S1310 of processing, the job-Z spare server (1) 151Z in the monitoring/backup site 150 may be able to join the cluster system 110Z to serve as the standby server. Note that when all the servers in the active site have failed, the job-Z spare server (1) 151Z in the monitoring/backup site 150 may serve as the active server.

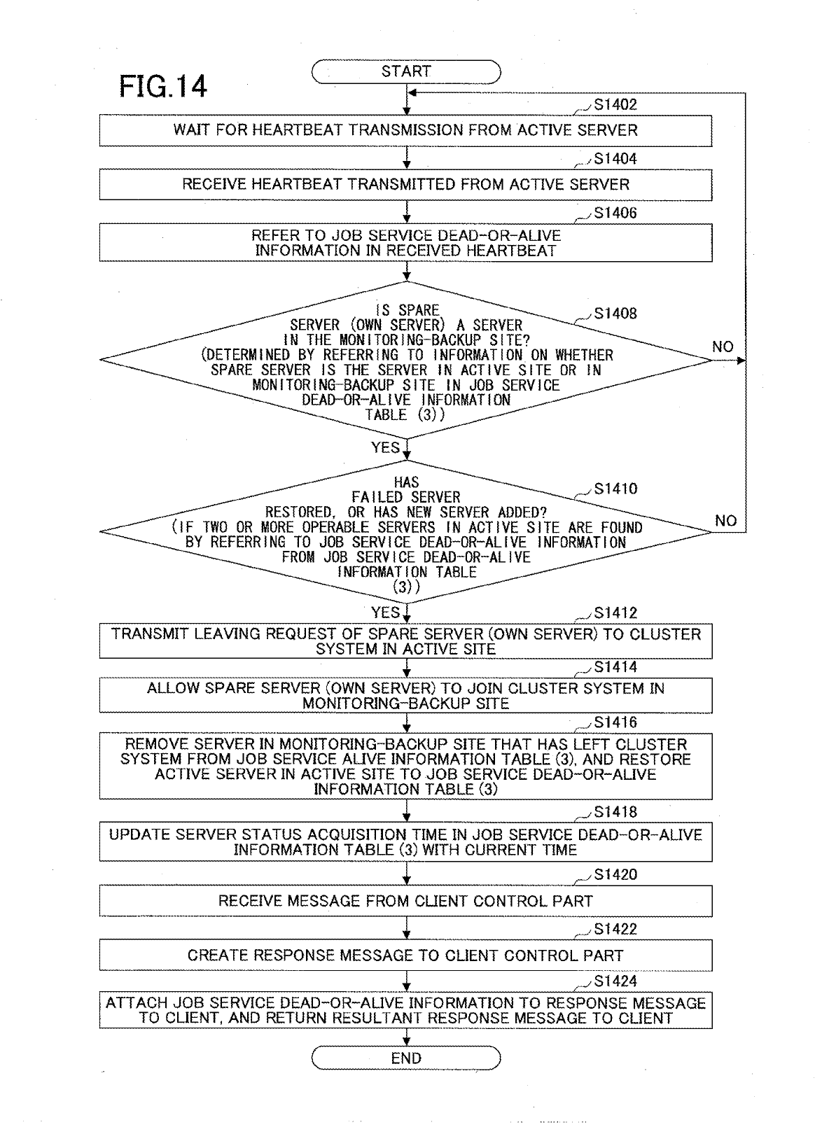

FIG. 14 is a flowchart illustrating an outline of a process in which the job-Z spare server (1) 151Z leaves the cluster system 110Z.

In step S1402, the job-Z spare server (1) 151Z waits for heartbeat transmission from the active server.

In step S1404, the job-Z spare server (1) 151Z receives the heartbeat transmitted from the active server.

In step S1406, the job-Z spare server (1) 151Z refers to the job service dead-or-alive information in the received heartbeat. Note that the job service dead-or-alive information may also be acquired from the message multicast transmitted from the client 180. Thus, the job service dead-or-alive information may be acquired by any one of the above routes.

In step S1408, it is determined whether the job-Z spare server (1) 151Z is a server in the monitoring/backup site. Whether the job-Z spare server (1) 151Z is a server in the monitoring/backup site may be determined by verifying location of the server for the job service dead-or-alive information table (3) 285 and referring to information on whether the job-Z spare server (1) 151Z is the server in the active site 110 or the server in the monitoring/backup site 150 in the job service dead-or-alive information table (3) 285. It may be possible to prevent the servers in the active site 110 from actively leaving the cluster system 110Z by verifying whether the job-Z spare server (1) 151Z is a server in the active site or a server in the monitoring/backup site. If the determination in step S1408 is “NO”, step S1402 is processed again (back to step S1402). If the determination in step S1408 is “YES”, step S1410 is processed.

In step S1410, it is determined whether the failed server of the cluster system 110Z in the active site is restored, or a new server is added. Whether the failed server is restored, or a new server is added may be determined based on whether the number of operable servers in the active site 110 is two or more by referring to the job service dead-or-alive information of the job service dead-or-alive information table (3) 285. This case indicates that a single point of failure (SPOF) is eliminated from the active site 110. If the determination in step S1410 is “NO”, step S1402 is processed again (back to step S1402). If the determination in step S1410 is “YES”, step S1412 is processed.

In step S1412, a leaving request 1101 of the job-Z spare server (1) 151Z (own server) is transmitted to the cluster system 110Z in the active site. It is preferable that the job-Z spare server (1) 151Z actively leave the cluster system 110Z in the active site. The job-Z spare server (1) 151Z may leave the cluster system 110Z in the active site by performing step S1412 of processing.

In step S1414, the job-Z spare server (1) 151Z (own server) joins the cluster system in the monitoring/backup site. It is preferable that the job-Z spare server (1) 151Z actively join the cluster system in the monitoring/backup site 150. The job-Z spare server (1) 151Z (own server) may join a cluster system that the job-Z spare server (1) 151Z (own server) has joined previously. Alternatively, the job-Z spare server (1) 151Z (own server) may join a new cluster system. Further, if there is no cluster system that the job-Z spare server (1) 151Z (own server) is able to join in the monitoring/backup site 150, no joining processing of the job-Z spare server (1) 151Z (own server) may be performed.

In step S1416, the job-Z spare server (1) 151Z (own server) in the monitoring/backup site that has left the cluster system is removed from the job service dead-or-alive information table (3) 285, and the restored active server in the active site is added to the job service dead-or-alive information table (3) 285.

In step S1418, the server status acquisition time in the job service dead-or-alive information table (3) 285 is updated with a current time.

In step S1420, the job-Z spare server (1) 151Z (own server) receives a processing request message from the client control part 220.

In step S1422, the job-Z spare server (1) 151Z (own server) creates a response message to the client control part 220.

In step S1424, the job service dead-or-alive information stored in the job service dead-or-alive information table (3) 285 is attached to the response message to the client 180 that is an original transmitter of the processing request message, and the resultant response message is returned to the client 180. By performing the above step of processing, the job service dead-or-alive information table (1) 215 managed by the client 180 may be updated.

According to the steps S1402 to S1424 of processing, the job-Z spare server (1) 151Z (own server) may complete leaving the cluster system 110Z. Note that if the job-Z spare server (1) 151Z (own server) serves as the active server, failover processing is performed in addition to the above steps of processing.

As described above, according to the embodiments, the worst scenario to shut down the job service in the active site may be avoided in a simple and easy manner. Further, as for monitoring the cluster system, the load on the network may be reduced to a maximum extent. In addition, when the cluster system is running properly, the spare server in the monitoring/backup site may be effectively used for other job services.

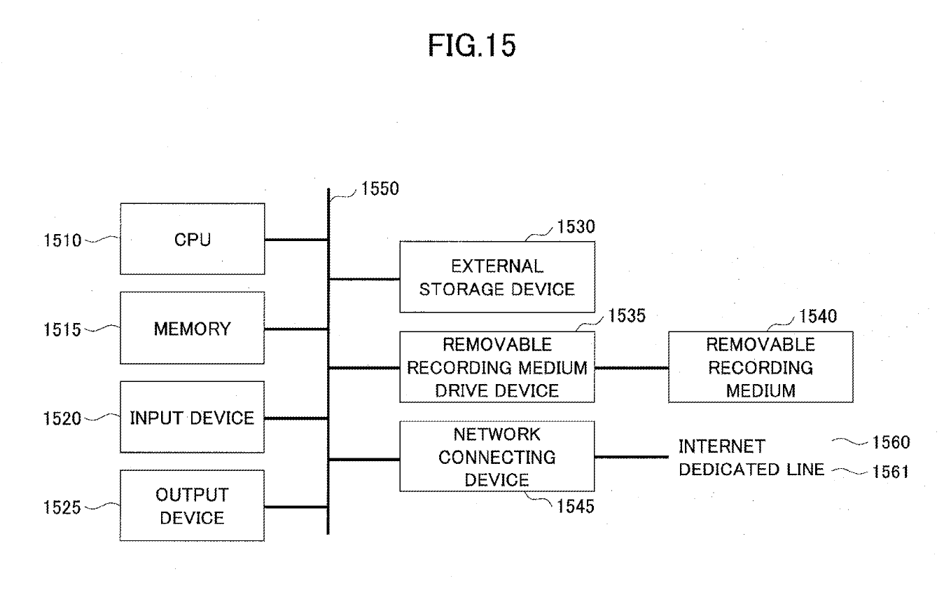

FIG. 15 is a diagram illustrating a hardware configuration of both a client and a server. Each of the client and the server includes a CPU 1510, a memory 1515, an input device 1520, an output device 1525, an external storage device 1530, a removable recording medium drive device 1535, and a network connecting device 1545. The above components are mutually connected via a bus 1550. The removable recording medium drive device 1535 may be able to read from or write to a removable recording medium 1540. The network connecting device 1545 is connected to the Internet 1560, and a dedicated line 1561.

Note that the program may be stored in the removable recording medium 1540. The removable recording medium 1540 indicates at least one non-transitory and tangible recording medium having a structure. Examples of the removable recording medium 1540 includes a magnetic recording medium, an optical disk, a magneto-optical recording medium, and a nonvolatile memory. Examples of the magnetic recording medium include a hard disk drive (HDD), a flexible disk (FD), and a magnetic tape (MT). Examples of the optical disk include a digital versatile disc (DVD), a digital versatile disc random access memory (DVD-RAM), a compact disc-read only memory (CD-ROM), and a compact disc-recordable/rewritable memory (CD-R/CD-RW). Examples of the magneto-optical medium include a magneto-optical (MO) disk and the like.

According to the embodiments, useful information for monitoring server failure.

Note that the order of the embodiments associated with methods or programs recited in the claims may be changed insofar as they are consistent. Alternatively, plurality processes may be performed simultaneously. It is needless to say that the embodiments are contained within the technical scope of the claimed invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. Anon-transitory computer-readable medium storing a program, which causes a client device to execute a sequence of processing, the sequence of processing comprising:
generating, by a processor, a processing request message by attaching status information including information indicating a status of a first server device stored in a storage part to a processing request addressed to the first server device;
transmitting the generated processing request message to the first server device and a second server device monitoring the first server device; and
receiving from the first server device a new status information of the first server device.

2. The non-transitory computer-readable medium as claimed in claim 1, wherein
the status information is contained in a response message from the first server device corresponding to the processing request.

3. The non-transitory computer-readable medium as claimed in claim 1, wherein
the status information includes information indicating a status of a standby server device that operates when the first server has failed.

4. The non-transitory computer-readable medium as claimed in claim 1, wherein
the transmitting the generated processing request message includes multicast transmission processing.

5. The non-transitory computer-readable medium as claimed in claim 1, wherein
the status information includes information indicating a status of a job service provided by the first server device to the client device.

6. The non-transitory computer-readable medium as claimed in claim 1, wherein
the processing request message includes an instruction to request transmitting of the status information to the client device.

7. The non-transitory computer-readable medium as claimed in claim 1, further comprising:
generating a control message including current status information containing information indicating a current status of the first server device in a case where a predetermined time has elapsed from a time at which the client device has transmitted the processing request message to the second server device last, and the status information contained in the processing request message differs from the current status information; and
transmitting the control message at least to the second server device.

8. Anon-transitory computer-readable medium storing a program, which, when processed by a processor, causes a first server device and a second server device to execute a sequence of processing, the sequence of processing comprising:
causing the first server device to transmit status information including information indicating a status of the first server device to a client device; and
causing the second server device monitoring the first server device to receive from the client device a processing request message including the status information addressed to the first server device.

9. The non-transitory computer-readable medium as claimed in claim 8, wherein
the status information includes information indicating a status of a standby server device that operates when the first server has failed.

10. A method for monitoring computer failure performed by a client device, the method comprising:
generating a processing request message by attaching status information including information indicating a status of a first server device stored in a storage part to a processing request addressed to the first server device;
transmitting the generated processing request message to the first server device and a second server device monitoring the first server device; and
receiving from the first server device a new status information of the first server device.

11. A method for monitoring a computer, the method comprising:
causing a first server device to transmit status information including information indicating a status of the first server device to a client device; and
causing a second server device monitoring the first server device to receive from the client device a processing request message including the status information addressed to the first server device.

12. A client device comprising:
a processor configured to generate a processing request message by attaching status information including information indicating a status of a first server device stored in a storage part to a processing request addressed to the first server device; and
a network connecting device configured to transmit the generated processing request message to the first server device and a second server device monitoring the first server device, and receive a new status information of the first server device from the first server device.

13. The client device as claimed in claim 12, wherein
the status information is contained in a response message from the first server device corresponding to the processing request.

14. The client device method as claimed in claim 12, wherein
the status information includes information indicating a status of a standby server device that operates when the first server has failed.

15. The client device as claimed in claim 12, wherein
the network connecting device performs multicast transmission.

16. The client device as claimed in claim 12, wherein
the status information includes information indicating a status of a job service provided by the first server device to the client device.

17. The client device as claimed in claim 12, wherein
the processing request message includes an instruction to request transmitting of the status information to the client device.

18. The client device as claimed in claim 12, wherein
the processor generates a control message including current status information containing information indicating a current status of the first server device in a case where a predetermined time has elapsed from a time at which the client device has transmitted the processing request message to the second server device last and the status information contained in the processing request message differs from the current status information, and
the network connecting device transmits the control message at least to the second server device.

19. A system comprising:
a network connecting device of a first server device configured to cause the first server device to transmit status information including information indicating a status of the first server device to a client device; and
a network connecting device of a second server device configured to cause the second server device monitoring the first server device to receive from the client device a processing request message including the status information addressed to the first server device.

20. The system as claimed in claim 19, wherein
the status information includes information indicating a status of a standby server device that operates when the first server has failed.
